(19) United States
(12) Patent Application Publication
(10) Pub. No.: US 2011/0179189 A1
(43) Pub. Date: Jul. 21, 2011

(54) COMMUNICATION APPARATUS, METHOD OF CONTROLLING THE SAME, PROGRAM, AND STORAGE MEDIUM

(75) Inventor: Katsuhiro Wada, Kawasaki-shi (JP)

(73) Assignee: CANON KABUSHIKI KAISHA, Tokyo (JP)

(21) Appl. No.: 13/122,390

(22) PCT Filed: Dec. 22, 2009
(86) PCT No.: PCT/JP2009/071834

§ 371 Date: Apr. 1, 2011

(30) Foreign Application Priority Data
Dec. 26, 2008 (JP) 2008-333518

(51) Int. Cl. G06F 15/16

(52) U.S. Cl. 709/245

(57) ABSTRACT

A communication apparatus capable of preferentially selecting an address of a type having no lifetime set thereto or an address of a type having a lifetime which can be extended, depending on the use of the address to be selected. A client CPU acquires attribute information of each of a plurality of addresses in the apparatus, identifies addresses of a type having no lifetime set thereto or addresses of a type having a lifetime which can be extended, based on the acquired attribute information. The client CPU selects an address for use in communication with the external apparatus from the addresses, and determines a use of the address to be selected when selecting the same. When the use of the address to be selected is determined to be a specific one, the selection is caused to be performed preferentially from the addresses identified by the identification.

### TECHNICAL FIELD

The present invention relates to a communication apparatus that has a plurality of addresses and communicates with an external apparatus by using an address selected from the addresses, a method of controlling the communication apparatus, and a program for causing a computer to execute the method.

### BACKGROUND ART

Conventionally, various kinds of apparatuses including personal computers (PCs), printers, and multifunction peripherals (MFPs) have been known as apparatuses having the function of performing communication via a network, such as an intranet or the Internet. Today, Internet Protocols (IPs) are widely used among the apparatuses capable of performing communication via a network. In a method of using the Internet Protocols, specific addresses (IP addresses) are assigned to respective apparatuses whereby the apparatuses are identified from each other based on the IP addresses.

Under IPv4 (IP version 4) as a conventional IP protocol, terminals identify respective counterparts of communication being performed via network connection, using addresses each assigned one-to-one to a single network interface.

On the other hand, under IPv6 (IP version 6), which is recently coming into widespread use, a plurality of addresses are sometimes assigned to a single network interface. The plurality of addresses assigned to a single network specifically include addresses of the following types:

IP addresses (stateless addresses) automatically acquired by a terminal communicating to a router when the former is connected to the latter (see Literature 1).

IP addresses (privacy addresses) for protecting the privacy of the terminal (see Literatures 2 and 3).

IP addresses (link local addresses) each uniquely assigned to each individual network interface.

IP addresses allocated by a DHCP (Dynamic Host Configuration Protocol) server (see Literature 4).

Thus, an apparatus (communication apparatus) supporting the IPv6 addresses sometimes has an IPv4 address and a plurality of types of IPv6 addresses assigned to a single network interface thereof.

Further, for the apparatus (communication apparatus) having a plurality of IP addresses as described above, there has conventionally been proposed a method of selecting an IP address for communication (see Patent Literature 4).

### Citation List

### Literature

{Literature 1} Internet Engineering Task Force RFC 2462 “IPv6 Stateless Address Auto-configuration”<URL: http://www.ietf.org/rfc/rfc2462.txt>

{Literature 2} Internet Engineering Task Force RFC 3041 “Privacy Extensions for Stateless Address Auto-configuration in IPv6”<URL: http://www.ietf.org/rfc/rfc3041.txt>

{Literature 3} Internet Engineering Task Force RFC 4941 “Privacy Extensions for Stateless Address Auto-configuration in IPv6”<URL: http://www.ietf.org/rfc/rfc4941.txt>

{Literature 4} Internet Engineering Task Force RFC 3315 “Dynamic Host Configuration Protocol for IPv6”<URL: http://www.ietf.org/rfc/rfc3315.txt>

{Literature 5} Internet Engineering Task Force RFC 3484 “Default Address Selection for Internet Protocol version 6”<URL: http://www.ietf.org/rfc/rfc3484.txt>

### SUMMARY OF INVENTION

### Technical Problem

When a single apparatus has a plurality of IP addresses, the method of selecting an address for use in communication with an external apparatus from the IP addresses includes, for example, a method of selecting an address based on the length of a prefix, as disclosed in the above-mentioned Literature 5 (RFC 3484).

However, there are various types of addresses categorized, for example, as follows: type (1) having an associated lifetime which can be extended, type (2) having an associated lifetime which cannot be extended, and type (3) having no associated lifetime.

Further, if an address is selected from the IP addresses according to RFC 3484, an address of type (2) having an associated lifetime which cannot be extended is selected, which sometimes causes a problem.

More specifically, when the selected address is used as a source address of data to be transmitted from a communication apparatus to an external apparatus, the use of the address is temporary and hence there is no need to continuously use the same address. This causes no particular problem even if the used address belongs to any of types (1) to (3).

However, in a case where a selected address is to be registered in an external apparatus for later use by the external apparatus, an address of type (2) having an associated lifetime which cannot be extended is not suited to the use. This is because when time comes for the external apparatus to actually use the address, it is sometimes after the lifetime of the address has already expired and the address may have been replaced by another. In such a case, it is impossible to perform normal communication.

This problem needs to be considered particularly when an address is selected as a notification destination, in subscribing to WS-Eventing (Web Services Eventing) that notifies events occurring in a server to clients that are registered in the server in advance. More specifically, if a terminal, i.e. a client registers an address of type (2) having an associated lifetime which cannot be extended, as an event notification destination, the terminal, which requested notification of events, cannot receive notifications after the associated lifetime of the address expires. Further, in spite of the fact that the address as the notification destination no longer exists, the server is required to continuously perform useless processing for notifying events to the no-longer-existing notification destination.

The present invention has been made in view of these problems, and provides a communication apparatus which is capable of preferentially selecting an address of a type having no associated lifetime or an address of a type having an associated lifetime which is extendable, depending on the use of the address to be selected, a method of controlling the communication apparatus, a program for causing a computer to execute the method, and a computer-readable storage medium storing the program.

### Solution to Problem

Accordingly, in a first aspect of the present invention, there is provided a communication apparatus that has a plurality of addresses and communicates with an external apparatus using an address selected from the plurality of addresses, comprising an acquisition unit configured to acquire attribute information concerning each of the plurality of addresses, an identification unit configured to identify addresses of a type having no lifetime set thereto or addresses of a type having a lifetime which can be extended, from the plurality of addresses, based on the attribute information acquired by the acquisition unit, a selection unit configured to select an address for use in communication with the external apparatus from the plurality of addresses, a determination unit configured to determine a use of the address to be selected, when the selection unit selects the address for use in communication with the external apparatus, and a control unit configured to control the selection unit such that when the use of the address to be selected is determined to be a specific one as a result of determination by the determination unit, the selection unit performs selection preferentially from the addresses identified by the identification unit out of the plurality of addresses.

Accordingly, in a second aspect of the present invention, there is provided a method of controlling a communication apparatus that has a plurality of addresses and communicates with an external apparatus using any address selected from the plurality of addresses, comprising acquiring attribute information concerning each of the plurality of addresses, identifying addresses of a type having no lifetime set thereto or addresses of a type having a lifetime which can be extended, from the plurality of addresses, based on the attribute information acquired by the acquiring, selecting an address for use in communication with the external apparatus from the plurality of addresses, determining a use of the address to be selected, when the selecting selects the address for use in communication with the external apparatus, and controlling the selecting such that when the use of the address to be selected is determined to be a specific one as a result of determination by the determining, the selecting performs selection preferentially from the addresses identified by the identification unit out of the plurality of addresses.

Accordingly, in a third aspect of the present invention, there is provided a program for causing a computer to execute the method of controlling the communication apparatus.

Accordingly, in a fourth aspect of the present invention, there is provided a computer-readable storage medium storing a program for causing a computer to execute the method of controlling the communication apparatus.

### ADVANTAGEOUS EFFECTS OF INVENTION

According to the present invention, it is possible to preferentially select an address of a type having no lifetime set thereto or addresses of a type having a lifetime which can be extended, depending on the use of the address to be selected.

Further features of the present invention will become apparent from the following description of exemplary embodiments with reference to the attached drawings.

### BRIEF DESCRIPTION OF DRAWINGS

FIG. 1 is a block diagram showing an example of the software configuration of a client PC as a communication apparatus according to a first embodiment of the present invention.

FIG. 2 is a schematic diagram of the client PC and a server PC connected via a network.

FIG. 3 is a block diagram showing an example of the hardware configuration of the client PC.

FIG. 4 is a flowchart of an address selecting process executed by the client PC.

FIG. 5 is a view showing an example of address information stored in an address information storage section of a communication library of the client PC.

FIG. 6 is a view showing another example of address information stored in the address information storage section of the communication library of the client PC.

FIG. 7 is a view showing an example of a communication use-selecting screen displayed on a display section of a client PC as a communication apparatus according to a second embodiment of the present invention.

FIG. 8 is a flowchart of an address selecting process executed by the client PC.

FIG. 9 is a flowchart of an address selecting process executed by a client PC as a communication apparatus according to a third embodiment of the present invention.

### DESCRIPTION OF EMBODIMENTS

The present invention will now be described in detail below with reference to the drawings showing embodiments thereof.

In each of first to third embodiments, a description will be given of a process in which an apparatus having a plurality of IP addresses selects an IP address thereof for use in communication with an external apparatus. Specifically, the apparatus having a plurality of IP addresses normally selects an IP address in the order of priority decided according to RFC (Request for Comments) 3484. However, particularly when the use of the selected address is a specific one, an address that can be used in a more fixed manner (an address of a type having no lifetime set thereto or an address of a type having a lifetime which can be extended) is selected.

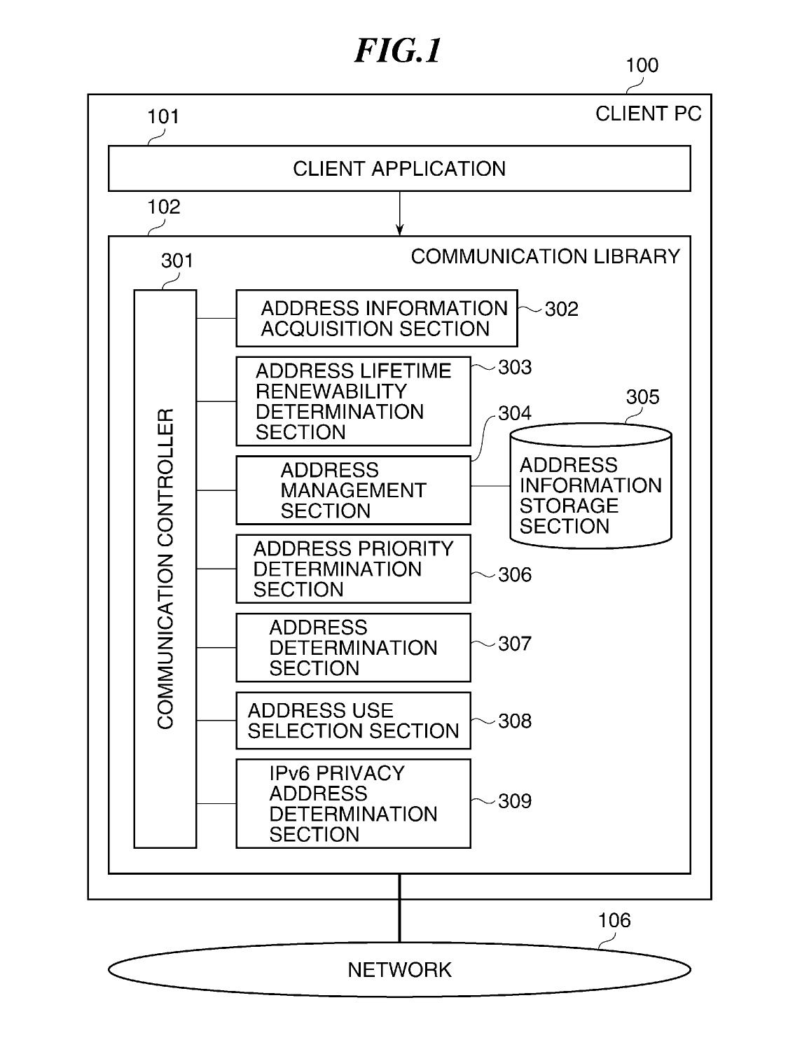

First, the configurations of a client PC as a communication apparatus according to the first embodiment and a server PC will be described in detail with reference to FIGS. 1 to 3.

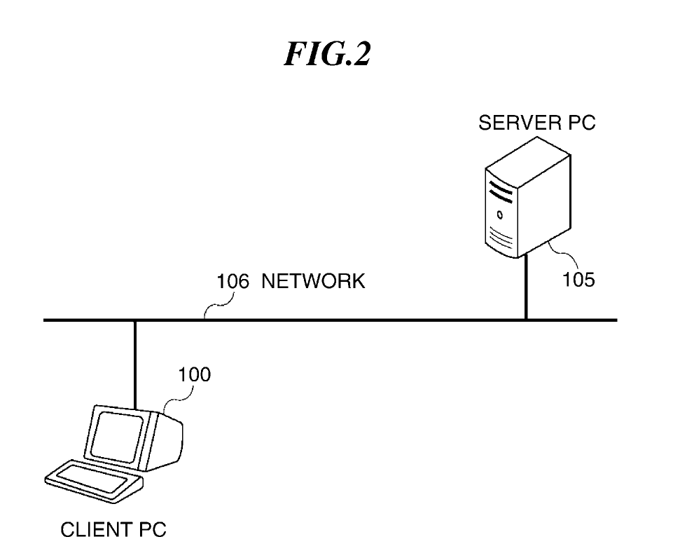

FIG. 2 is a schematic diagram of the client PC as the communication apparatus according to the embodiment and the server PC connected to each other via a network.

Referring to FIG. 2, the client PC 100 and the server PC 105 are configured such that they can communicate with each other via the network 106, such as a LAN or a WAN. The client PC 100 has an IP address for communicating with various types of apparatuses including the server PC 105 on the network 106. The client PC 100 is capable of having a plurality of addresses. The server PC 105 provides services in response to requests transmitted from the client PC 100 via the network 106.

Examples of the services provided by the server PC 105 include WWW (World Wide Web), DNS (Domain Name System), electronic mail, and so forth. Further, they may include services providing the functions of the SNMP (Simple Network Management Protocol) agent and the WS-Eventing. In the services provided by the server PC 105, the protocols for use in communication between the server PC 105 and the client PC 100 are not particularly limited insofar as the communication uses IP addresses.

When the client PC 100 has a plurality of IP addresses, as described above, the client PC 100 selects an address from the IP addresses according to the address (destination address) of the server PC 105 when the client PC 100 communicates to the server PC 105. The address selected here is used as a source address of data transmitted from the client PC 100 to the server PC 105.

Further, also when the client PC 100 registers an address thereof in the server PC 105, it is necessary to select an appropriate address. For example, when setting up SNMP trap notification or subscribing to WS-Eventing, the client PC 100 selects an address from the IP addresses and registers the selected address in the server PC 105 as the address of its own (event notification destination). The server PC 105 notifies events occurring therein to the registered address.

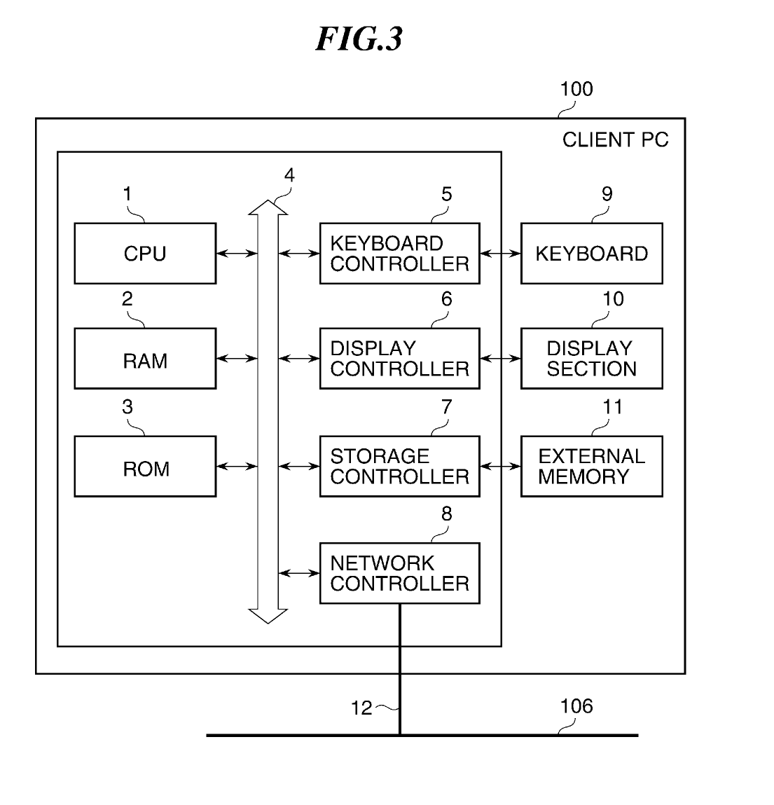

FIG. 3 is a block diagram showing an example of the hardware configuration of the client PC 100.

Referring to FIG. 3, the client PC 100 includes a CPU 1, a RAM 2, a ROM 3, a system bus 4, a keyboard controller 5, a display controller 6, a storage controller 7 and a network controller 8. Further, the client PC 100 includes a keyboard 9, a display section 10, an external memory 11 and a bidirectional interface 12. Since the server PC 105 is identical in configuration to the client PC 100, illustrations and descriptions thereof are omitted.

The CPU 1 performs centralized overall control of the devices connected to the system bus 4. The CPU 1 performs various types of processing including document processing for processing a document which contains graphics, images, text, and tables (including spreadsheets) in a mixed manner, based on an application (document processing program or the like) stored in a program ROM of the ROM 3 or in the external memory (HD) 11. Further, the CPU 1 performs various processes shown in flowcharts, described hereinafter, based on a program according to the present embodiment. Further, the CPU 1 carries out processing for rasterizing an outline font e.g. into a display RAM secured in the RAM 2, to thereby display character strings on the display section 10 via the display controller 6.

Furthermore, based on a command instructed using a mouse cursor (not shown) or the like displayed on the display section 10, the CPU 1 opens a selected one of various windows registered in the client PC and executes an associated one of various kinds of data processing. In the case of using a client application 101 (see FIG. 1) or a server application (not shown), the user can open a configuration window for the application to configure various settings on the window.

The RAM 2 serves as a main memory and a work area of the CPU 1. The ROM 3 is comprised of a font ROM, the program ROM and a data ROM, none of which are shown. The font ROM or the external memory 11 stores font data and the like e.g. for use in document processing. The program ROM or the external memory 11 stores an operating system (OS) as a control program of the CPU 1, the program according to the present embodiment, and so forth. The data ROM or the external memory 11 stores various kinds of data e.g. for use in document processing. The programs stored in the external memory 11 are each loaded into the RAM 2 when it is executed.

The keyboard controller 5 controls input information from the keyboard 9 and a pointing device (not shown). The display controller 6 controls display on the display section 10. The storage controller 7 controls writing and reading of data into and from the external memory 11. The network controller 8 controls communication via the bidirectional interface 12 and the network 106. The keyboard 9 is used for various inputs. The display section 10 displays graphics, images, text, tables, and so forth. The external memory 11 is comprised of a hard disk (HD), a floppy disk (registered trademark) (FD) and the like, and stores a boot program, various application programs, font data, user files, edited files, etc.

FIG. 1 is a block diagram showing an example of the software configuration of the client PC 100 as the communication apparatus according to the present embodiment.

Referring to FIG. 1, the client PC 100 is comprised of the client application 101, and a communication library 102. The communication library 102 includes a communication controller 301, an address information acquisition section 302, an address lifetime renewability determination section 303, an address management section 304 and an address information storage section 305. Further, the communication library 102 includes an address priority determination section 306, an address determination section 307, an address use selection section 308 and an IPv6 privacy address determination section 309.

In response to a request from the client application 101, the client PC 100 communicates with the server PC 105 connected to the network 106, via a stub object (not shown) and the communication library 102.

In the communication library 102, the communication controller 301 determines attribute information of an address acquired by the address information acquisition section 302, and based on the result of the determination, selects an address to be actually used for communication. Further, the communication controller 301 executes communication between the client application 101 and the server PC 105 using the selected address.

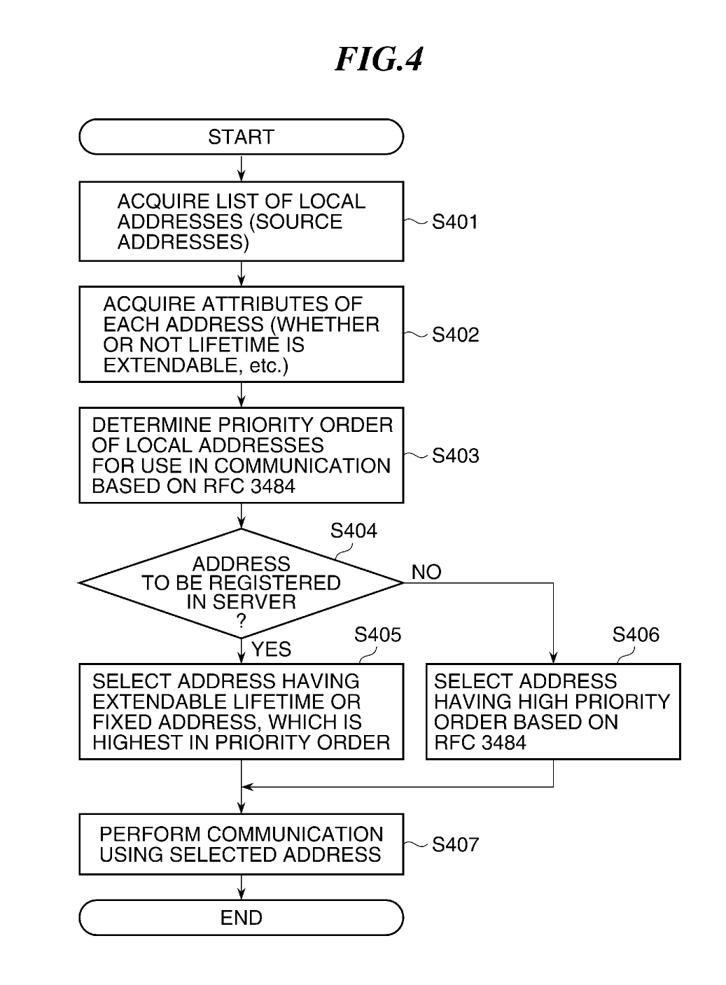

The address information acquisition section 302 acquires, from the OS, information on addresses usable in the communication and an address (event notification destination address) to be registered in the server PC 105. The acquired information on addresses includes an address list and attribute values of each address. The attribute values of each address include an address version, a preferred lifetime, a valid lifetime, a prefix, an address format, and so forth. The acquisition of the address list will be described in detail with reference to FIG. 4.

The address lifetime renewability determination section 303 determines whether or not the lifetime of each address can be renewed (can be extended to use the same address), based on the attribute values of each address acquired by the address information acquisition section 302.

The address management section 304 manages the address information acquired by the address information acquisition section 302 and the address information determined by the address lifetime renewability determination section 303. The address information storage section 305 stores the address information managed by the address management section 304.

The address priority determination section 306 determines an order of priority of addresses according to the definition in RFC 3484, based on the address information stored in the address information storage section 305 and a communication destination address (destination address) with which the client PC 100 is to perform communication.

The address determination section 307 determines an address to be actually used for communication based on the result of determination by the address priority determination section 306. In doing this, the address determination section 307 also determines as to each of the addresses in the descending order of priority whether or not the communication destination address (destination address) is IP reachable for actual communication.

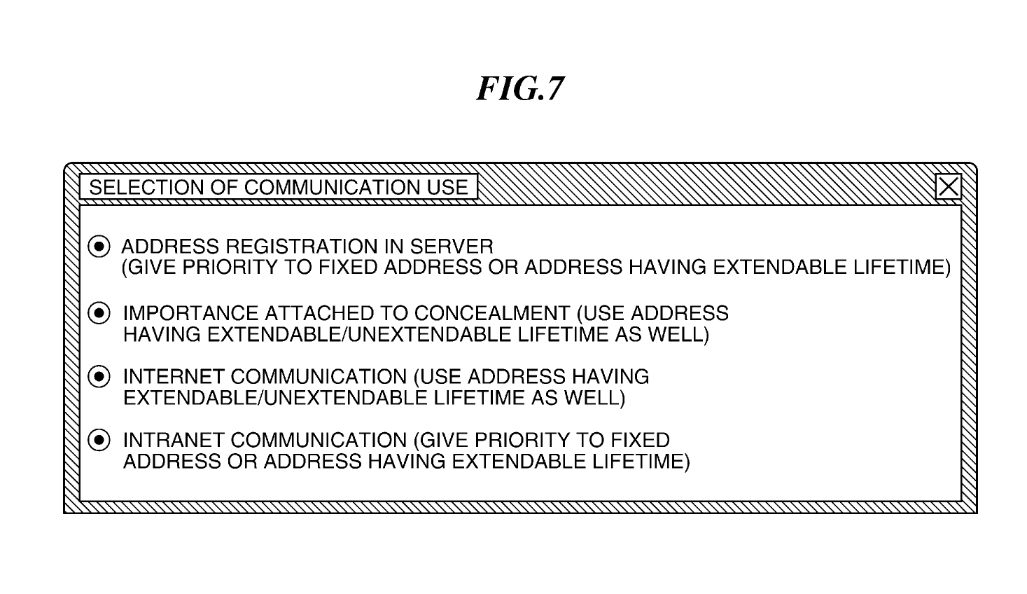

The address use selection section 308 determines the use of each address according to the purpose of communication of the client application 101. The method of determining the use of an address includes one which automatically performs the determination based on the purpose of communication of the client application 101 or the communication destination address (destination address) thereof. In the present embodiment, a description will be given of a method in which the client application 101 determines a communication use of an address and notifies the result of the determination to the communication library 102, by way of example. It should be noted that a method of selecting a communication use of an address from a communication use-selecting screen (see FIG. 7) will be given hereinafter in the description of a second embodiment of the present invention. The use of the address determined by the address use selection section 308 is stored in the address information storage section 305 by the address management section 304.

The IPv6 privacy address determination section 309 determines whether or not each address is a privacy address defined in RFC 3041 or RFC 4941. Further, the IPv6 privacy address determination section 309 determines the preferred lifetime and the valid lifetime of each address set by a router (not shown) or an address issuing server (not shown), the lifetime of the address set by the OS, and whether or not the lifetime can be renewed.

Next, the operation of the client PC 100 configured as described above according the present embodiment will be described with reference to FIGS. 4 to 6.

FIG. 4 is a flowchart of an address selecting process executed by the client PC 100. The present process is executed by the CPU 1 of the client PC 100, using the communication library 102.

Referring to FIG. 4, the address information acquisition section 302 of the communication library 102 of the client PC 100 acquires a list (address list) of local addresses (source addresses) from the OS (step S401). The address information acquisition section 302 stores the acquired address list in the address information storage section 305 via the address management section 304. The method of acquiring an address list from the OS includes one in which AI_PASSIVE flag is specified for getaddrinfo which is a socket function of the OS, together with IPv4 addresses and IPv6 addresses.

Next, the address information acquisition section 302 acquires address attributes (whether the valid lifetime of an address can be extended, etc.) (step S402). Specifically, as to the address list acquired in the step S401, the address information acquisition section 302 acquires, from the OS, information of whether or not the lifetime can be extended, the address version, the preferred lifetime, the valid lifetime, the prefix, and the address format, etc. of each address. The communication controller 301 stores the acquired address attributes in the address information storage section 305 via the address management section 304.

Next, the address priority determination section 306 determines the order of priority of the local addresses for use in communication based on RFC 3484 (step S403). In this case, the address priority determination section 306 determines the order of priority of the local addresses based on the address information stored in the address information storage section 305 and a communication destination address (destination address) designated by the client application 101.

Next, the address determination section 307 determines based on the designation from the client application 101 whether or not a local address for use in communication is an address to be registered in the server PC 105 (step S404). In this case, the address determination section 307 determines whether the local address is used as an IP address in the third layer (network layer) of the OSI reference model or an IP address used in another layer (IP address contained in data).

For example, the address determination section 307 determines that information of a communication address contained in the seventh layer (application layer), the sixth layer (presentation layer), the fifth layer (session layer) of the OSI reference model, or the like is to be registered in the server PC 105. Specifically, if the address is to be used as an event notification destination address specified by NotifyTo when requesting an event notification from the server PC 105 by WS-Eventing, the address determination section 307 determines that the address is to be registered in the server PC 105. Details of specifications of WS-Eventing are provided at the following URL:

<URL: http://www.w3.org/Submission/WS-Eventing/>

If the address determination section 307 determines in the step S404 that the local address is to be registered in the server PC 105, the address determination section 307 executes the following process: The address determination section 307 identifies addresses of a type having an associated lifetime which can be extended and addresses of a fixed type (having no associated lifetime). Then, from the identified addresses, the address determination section 307 selects an address with the highest priority order determined in the step S403, and sets the selected address to an address for use in actual communication (step S405). Then, the process proceeds to a step 407.

As described above, by preferentially using an address having an associated lifetime which can be extended or a address which is fixed, as an address to be registered in the server PC 105, it possible to dispense with or reduce the frequency of execution of a process for re-registering an address in the server PC 105, which is required when the address is changed.

More specifically, the address determination section 307 determines an address for use in actual communication based on an instruction from the client application 101, the communication destination address (destination address), and the result of determination by the address priority determination section 306 in the step S403. In doing this, the address determination section 307 also determines as to each of the addresses in the descending order of priority whether or not the communication destination address (destination address) is IP reachable for actual communication.

On the other hand, if the address determination section 307 determines in the step S404 that the address is not to be registered in the server PC 105, the address determination section 307 executes the following process: The address determination section 307 selects an address for use in actual communication from the address priority list generated based on RFC 3484 by the address priority determination section 306 in the step S403 (step S406), and then the process proceeds to the step S407.

After the selection of the address is terminated in the step S405 or S406, the communication controller 301 communicates with the server PC 105 using the address selected in the step S405 or S406 (step S407), followed by terminating the present process.

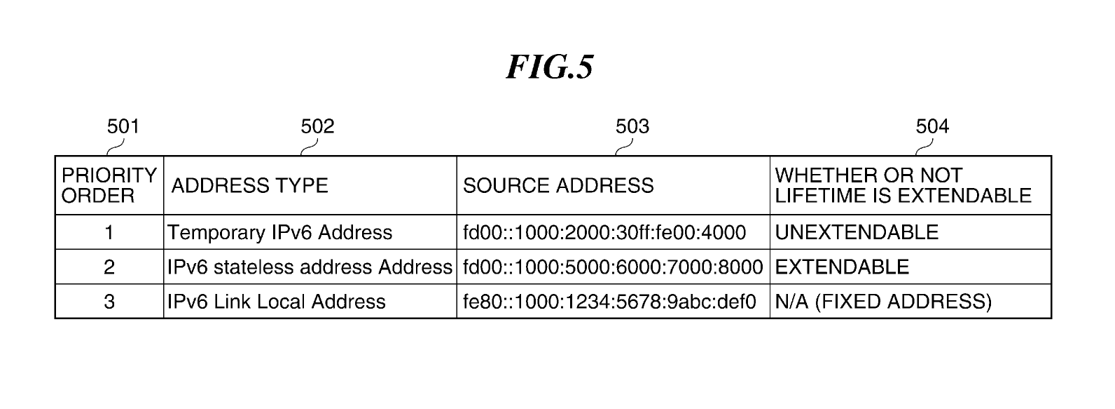

FIG. 5 is a view showing an example of address information stored in the address information storage section 305 of the communication library 102 of the client PC 100.

FIG. 5 shows an example of the address information generated in the step S403 in FIG. 4 and stored in the address information storage section 305. The address information is comprised of priorities 501, address types 502, source addresses (local addresses) 503 and information 504 concerning whether or not the lifetime can be extended (unextendable, extendable, or N/A (fixed address). In the example illustrated in FIG. 5, priorities are assigned in the order of “1”, “2” and “3” to addresses of the types which are unextendable, extendable, and N/A (fixed address i.e. an address having no lifetime set thereto), in respect of lifetime, respectively.

The FIG. 5 example shows the address type 502 and the priority 501 of each source address (local address) 503 to be used for the destination address of fd00::1000:4000:3000:2000:1000. This example includes the information 504 concerning whether or not the lifetime can be extended, as an example of the address attributes. According to the order of priority based on RFC 3484, the priority of each address becomes lower in the following order:
fd00::1000:2000:30ff:fe00:4000
fd00::1000:5000:6000:7000:8000
fe80::1000:1234:5678:9abc:def0

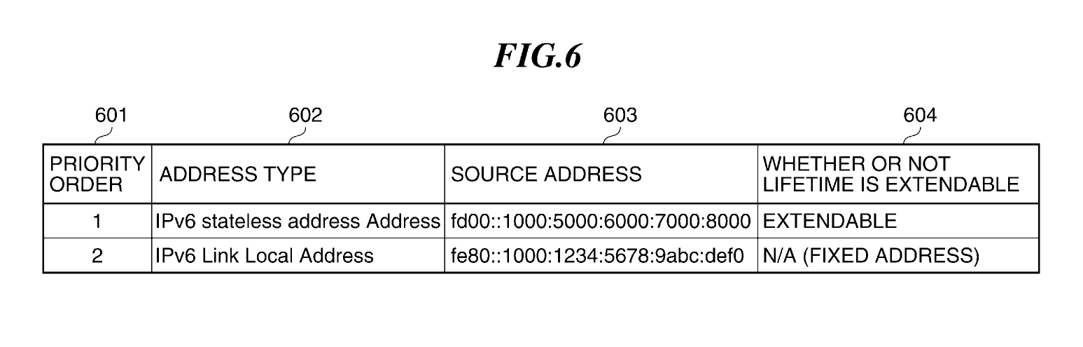

FIG. 6 is a view showing another example of address information stored in the address information storage section 305 of the communication library 102 of the client PC 100. The address information is comprised of priorities 601, address types 602, source addresses (local addresses) 603 and information 604 concerning whether or not the lifetime can be extended (unextendable, extendable, or N/A (fixed address). In the FIG. 6 example, the priorities “1” and “2” are assigned to addresses of types which are extendable and N/A (fixed address) in respect of lifetime, respectively.

More specifically, the FIG. 6 examples shows the address type 602 and the priority 601 of each source addresses (local address) 603 to be used for the destination address fd00::1000:4000:3000:2000:1000. This example includes the information 604 concerning whether or not the lifetime can be extended, as an example of the address attributes. The address fd00::1000:2000:30ff:fe00:4000, which has the highest priority in the FIG. 5 example, is deleted since it is an address the lifetime of which cannot be extended. In the FIG. 6 example, the address fd00::1000:5000:6000:7000:8000 is determined to have the highest priority and is used as an address to be registered in the server PC 105.

As described above, by selecting an address to be registered in the server PC 105 preferentially from addresses each having an associated lifetime which can be extended, it is possible to dispense with or reduce the frequency of execution of the process for re-registering an address in the server PC 105, which is required when the address is changed.

Although in the present embodiment, an address to be registered in the server PC 105 is selected, by way of example, this is not limitative, but similarly to the above, the present invention is applicable to a case where a source address is selected which is an IP address in the third layer (network layer) of the OSI reference model.

Next, a description will be given of the second embodiment of the present invention, which is distinguished from the above-described first embodiment by a point mentioned below. The other elements in the present embodiment are identical to the corresponding ones in the first embodiment (FIGS. 1, 2, 3). Therefore, the corresponding elements are denoted by the same reference numerals, and description thereof is omitted.

In the above-described first embodiment, the description has been given of a case where the communication use of an address is selected by the communication library 102 according to the purpose of communication of the client application 101 of the client PC 100.

In the present embodiment, the description will be given of a case where the communication use of an address is selected by the communication library 102 based on an instruction from the user via the communication use-selecting screen (FIG. 7). Selection information corresponding to an item selected by the user from the communication use-selecting screen is transmitted to the address use selection section 308 by a user interface section (not shown). The address use selection section 308 determines the communication use of the address based on the selection information. This makes it possible for the user to select a communication address that is suitable for a desired communication use.

FIG. 7 is a view showing an example of the communication use-selecting screen displayed on the display section 10 of the client PC 100 according to the present embodiment.

Referring to FIG. 7, on the communication use-selecting screen (dialog), there are displayed the following items: Address Registration in Server (Give priority to fixed address or address having extendable lifetime); Importance Attached to Concealment (Use address having extendable/unextendable lifetime as well); Internet communication (Use address having extendable/unextendable lifetime as well); and Intranet communication (Give priority to fixed address or address having extendable lifetime).

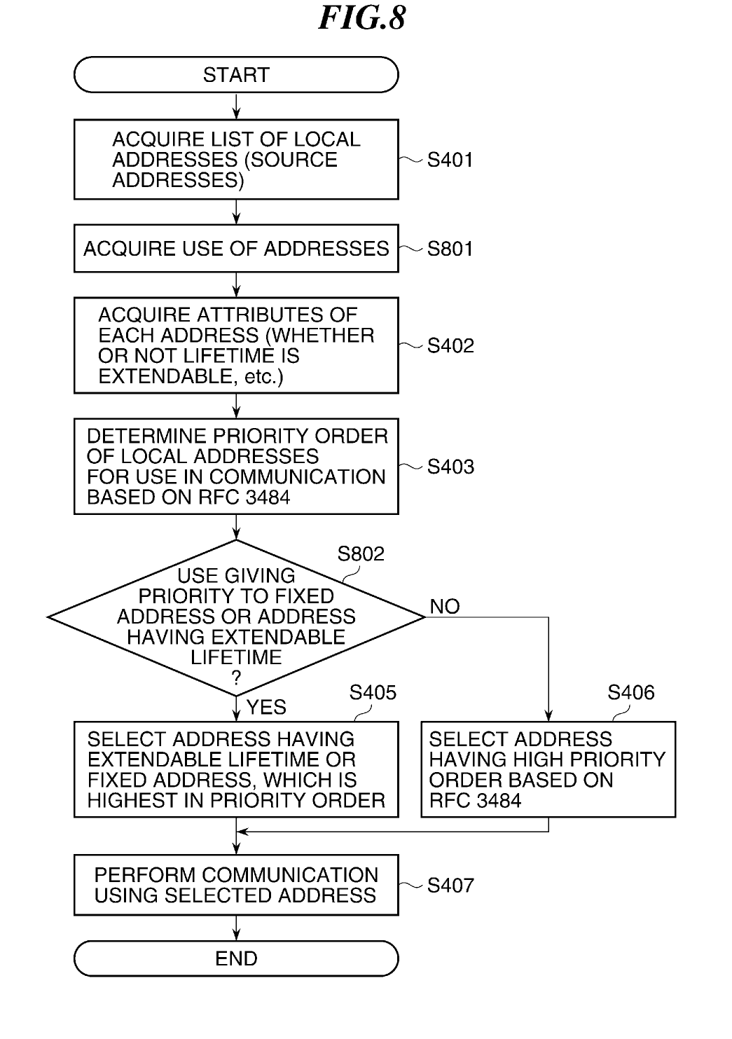

FIG. 8 is a flowchart of an address selecting process executed by the client PC 100 according to the present embodiment. The present process is executed by the CPU 1 of the client PC 100, using the communication library 102.

In FIG. 8, the steps S401 to S403 and the steps S405 to S407 are the same as the steps S401 to S403 and the steps S405 to S407 in FIG. 4, respectively. Therefore, they are denoted by the same step numbers, and description thereof is omitted. In the following, a description will be given of only different points from the address selecting process in FIG. 4.

In a step S801, the address use selection section 308 of the communication library 102 of the client PC 100 acquires the use of the address according to a user communication purpose. Now, a method of selecting the user communication purpose will be described by taking an example in which the user interface section, which has accepted user selection of the use of the address from the FIG. 7 communication use-selecting screen, transmits selection information to the address use selection section 308.

The address use selection section 308 determines the use of the address based on the selection information. The result of the determination by the address use selection section 308 is stored in the address information storage section 305 via the address management section 304, and is used when the address priority determination section 306 determines the order of priority of the address.

In a step S802, the address determination section 307 determines whether or not the address used in communication is for use in communication giving priority to a fixed address or an address having an extendable lifetime, based on the use of the address selected by the user on FIG. 7 communication use-selecting screen.

If the address determination section 307 determines that the address used in communication is for use in communication giving priority to a fixed address or an address having extendable lifetime, the address determination section 307 executes the step S405. On the other hand, if the address determination section 307 determines that the address used in communication is not for use in communication giving priority to a fixed address or an address having extendable lifetime, the address determination section 307 executes the step S406.

As described in detail above, according to the present embodiment, in selecting an address for use in communication, it is possible to select an address matching the use of the address designated by the user.

Next, a description will be given of a third embodiment of the present invention, which is distinguished from the above-described first embodiment by a point described below. The other elements in the present embodiment are identical to the corresponding ones in the first embodiment (FIGS. 1, 2, 3). Therefore, the corresponding elements are denoted by the same reference numerals, and description thereof is omitted.

In the above-described second embodiment, the description has been given of a case where the communication library 102 of the client PC 100 determines whether or not it is possible to renew the lifetime of each address. However, depending on a general OS or a specific OS version, it is sometimes impossible to directly acquire address attributes for use in determining whether or not the lifetime of an address can be extended.

In the present embodiment, a description will be given of a case where the communication library 102 determines whether or not the lifetime of an address can be extended, when it is impossible to directly acquire address attributes for use in determining the whether or not the lifetime of the address can be extended. Particularly, as to the privacy address defined in RFC 3041 or RFC 4941, it is impossible to renew i.e. update the lifetime thereof due to its characteristics. Further, it is sometimes impossible to determine whether or not the lifetime can be extended from the preferred lifetime and valid lifetime set by a router or an address issuing server, and the attribute values of the OS. In the present embodiment, whether or not the lifetime can be extended is determined by the following process,

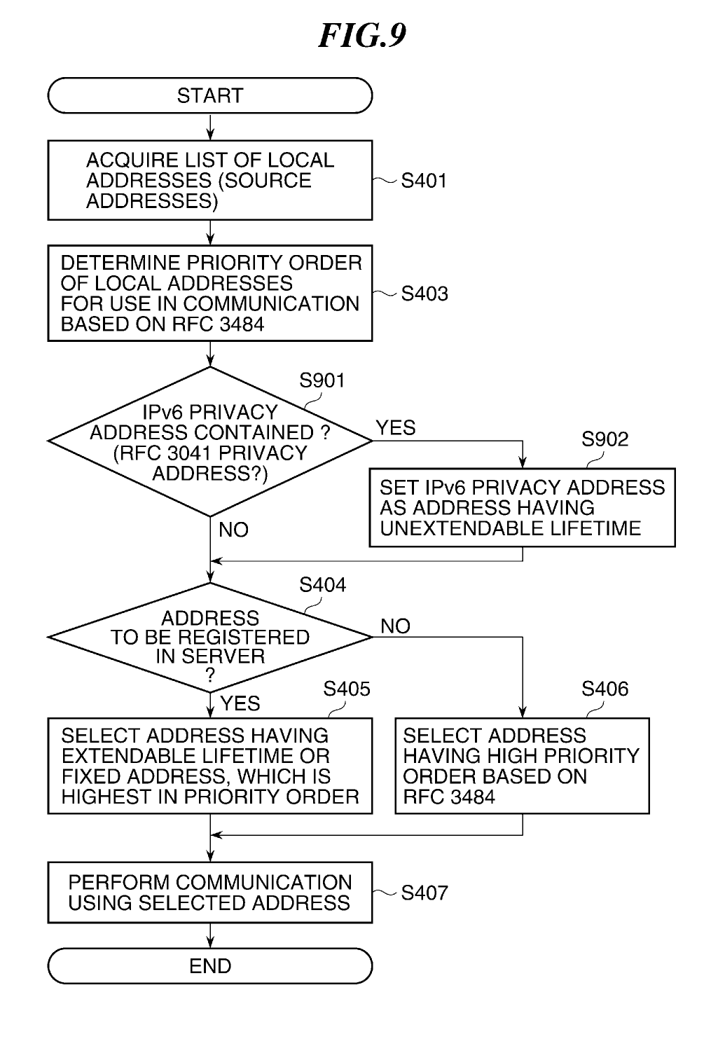

FIG. 9 is a flowchart of an address selecting process executed by a client PC 100 as a communication apparatus according to the present embodiment. The present process is executed by the CPU 1 of the client PC 100, using the communication library 102.

In FIG. 9, the step S401 and the steps S403 to S407 are the same as the step S401 and the steps S403 to S407 in FIG. 4, respectively. Therefore, they are denoted by the same step numbers, and description thereof is omitted. In the following, a description will be given of only different points from the address selecting process in FIG. 4.

In a step S901, the IPv6 privacy address determination section 309 performs address format determination, i.e. determines whether each address acquired in the step S401 in FIG. 4 is a privacy address defined in RFC 3041 or RFC 4941. When the address includes an attribute value indicative of a temporary address as an attribute value of the OS and at the same time does not conform to the definition in the EUI-64 format (predetermined format) determined by IEEE, the IPv6 privacy address determination section 309 determines that the address is a privacy address.

For the EUI-64 format determined by IEEE, refer to the following specification of URL: http://standards.ieee.org/regauth/oui/tutorials/EUI64.html

If the IPv6 privacy address determination section 309 determines that the address list acquired in the step S401 includes no privacy addresses, the process proceeds to the step S404, whereas if the IPv6 privacy address determination section 309 determines that the address list acquired in the step S401 includes a privacy address or privacy addresses, the process proceeds to a step S902.

In the step S902, the IPv6 privacy address determination section 309 determines that each IPv6 privacy address is an address having a lifetime which cannot be extended, and configures the address as such.

According to the above-described process, it is possible to perform the following determination, particularly as to the privacy addresses defined in RFC 3041 or RFC 4941. That is, also when it is impossible to determine whether or not the lifetime of an address can be extended from the preferred lifetime and the valid lifetime set by a router or an address issuing server, and the attribute values of the OS, it is possible to accurately determine that the address is a type having a lifetime which cannot be renewed.

As described in detail heretofore, according to the present embodiment, when selecting an address for use in communication from addresses including particularly a privacy address defined in RFC 3041 or RFC 4941, it is possible to select an address while determining whether or not the lifetime of the address can be extended.

Although in the above-described embodiments, the description has been given of the configuration in which the client PC and the server PC are connected to a network, by way of example, this is not limitative, but other apparatuses than the PCs, such as a network apparatus, an information processing apparatus, and a communication apparatus, may connected to a network.

Although in the above-described embodiments, the description has been given of the configuration in which the client PC and the server PC are connected by the network of a LAN or a WAN, by way of example, this is not limitative, but it is possible to apply various types of connection methods, such as a network other than the LAN or the WAN, a wireless LAN, such as IEEE 802.11, and a serial interface, such as IEEE 1394.

Although in the above-described embodiments, the present invention is applied to personal computers (PCs), by way of example, this is not limitative, but the present invention can also be applied to printers, multifunction peripherals (MFPs), and so forth.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

100 client PC
105 server PC
106 network
301 communication controller
302 address information acquisition section
303 address lifetime renewability determination section
304 address management section
305 address information storage section
306 address priority determination section
307 address determination section
308 address use selection section
309 IPv6 privacy address determination section

1. A communication apparatus that has a plurality of addresses and communicates with an external apparatus using an address selected from the plurality of addresses, comprising:
an acquisition unit configured to acquire attribute information concerning each of the plurality of addresses;
an identification unit configured to identify addresses of a type having no lifetime set thereto or addresses of a type having a lifetime which can be extended, from the plurality of addresses, based on the attribute information acquired by said acquisition unit;
a selection unit configured to perform selection of selecting an address for use in communication with the external apparatus from the plurality of addresses;
a determination unit configured to determine whether or not the address to be selected with the selection is used as a notification destination to be notified an event occurring in the external apparatus, when said selection unit selects the address for use in communication with the external apparatus; and
a control unit configured to control said selection unit such that when the address to be selected is determined to be used as the notification destination said selection unit performs the selection preferentially from the addresses identified by said identification unit out of the plurality of addresses.

2. The communication apparatus according to claim 1, further comprising a decision unit configured to decide an order of priority of the plurality of addresses, and
wherein said control unit controls said selection unit such that when the address to be selected is determined to be used as the notification destination, said selection unit performs selection preferentially from the addresses identified by said identification unit, according to the order of priority decided by said decision unit.

3. The communication apparatus according to claim 1, further comprising a storage unit configured to store the attribute information acquired by said acquisition unit,
wherein said identification unit identifies the addresses based on the attribute information stored in said storage unit.

4. The communication apparatus according to claim 1, wherein the address selected by said selection unit is registered in the external apparatus as an address of the communication apparatus.

5.-6. (canceled)

7. The communication apparatus according to claim 1, wherein said determination unit performs the determination according to an instruction from a user.

8. The communication apparatus claim 1, wherein out of the plurality of addresses, addresses that are not in a predetermined format are identified by said identification unit as privacy addresses lifetime of which is unextendable.

9. A method of controlling a communication apparatus that has a plurality of addresses and communicates with an external apparatus using any address selected from the plurality of addresses, comprising:
an acquisition step of acquiring attribute information concerning each of the plurality of addresses;
an identification step of identifying addresses of a type having no lifetime set thereto or addresses of a type having a lifetime which can be extended, from the plurality of addresses, based on the attribute information acquired in said acquisition step;
a selection step of performing selection of selecting an address for use in communication with the external apparatus from the plurality of addresses;
a determination step of determining whether or not the address to be selected with the selection is used as a notification destination to be notified an event occurring in the external apparatus, when the address for use in communication with the external apparatus is selected in said selection step; and
a control step of controlling said selection step such that when the address to be selected is determined to be used as the notification destination, the selection is performed in said selection step preferentially from the addresses identified in said identification step out of the plurality of addresses.

10. A program for causing a computer to execute the method according to claim 9.

11. A computer-readable storage medium storing a program for causing a computer to execute the method according to claim 9.

12. The communication apparatus according to claim 2, further comprising a storage unit configured to store the attribute information acquired by said acquisition unit,
wherein said identification unit identifies the addresses based on the attribute information stored in said storage unit.

13. The communication apparatus according to claim 2, wherein the address selected by said selection unit is registered in the external apparatus as an address of the communication apparatus.

14. The communication apparatus according to claim 3, wherein the address selected by said selection unit is registered in the external apparatus as an address of the communication apparatus.

15. The communication apparatus according to claim 2, wherein said determination unit performs the determination according to an instruction from a user.

16. The communication apparatus according to claim 3, wherein said determination unit performs the determination according to an instruction from a user.

17. The communication apparatus according to claim 4, wherein said determination unit performs the determination according to an instruction from a user.

18. The communication apparatus according to claim 2, wherein out of the plurality of addresses, addresses that are not in a predetermined format are identified by said identification unit as privacy addresses lifetime of which is unextendable.

19. The communication apparatus according to claim 3, wherein out of the plurality of addresses, addresses that are not in a predetermined format are identified by said identification unit as privacy addresses lifetime of which is unextendable.

20. The communication apparatus according to claim 4, wherein out of the plurality of addresses, addresses that are not in a predetermined format are identified by said identification unit as privacy addresses lifetime of which is unextendable.

21. The communication apparatus according to claim 7, wherein out of the plurality of addresses, addresses that are not in a predetermined format are identified by said identification unit as privacy addresses lifetime of which is unextendable.
